(19) United States
(12) Patent Application Publication
(10) Pub. No.: US 2017/0119010 A1
(43) Pub. Date: May 4, 2017

(54) CONFECTIONERY PRODUCT

(71) Applicant: MARS, INCORPORATED, McLEAN, VA (US)

(72) Inventors: PETER ANTONY NAIDU-HUSBAND, BERKSHIRE (GB); YANN THIERRY HOCQUEL, BERKSHIRE (GB); SAMUEL ROBERT RALPH TARRATT, BERKSHIRE (GB); NICOS ANDREW CHARALAMBOUS, BERKSHIRE (GB); LEIGH SAMUEL STORAH, BERKSHIRE (GB); SOPHIE ALEXANDRA O'KELLY, BERKSHIRE (GB); BRUCE HANNANT, BERKSHIRE (GB); JESSICA VICTORIA HOLLWAY, BERKSHIRE (GB); BRIAN STOW, BERKSHIRE (GB); TIMOTHY HAROLD MOORE, WARWICKSHIRE (GB)

(73) Assignee: MARS, INCORPORATED, McLEAN, VA (US)

(21) Appl. No.: 15/317,949

(22) PCT Filed: Jun. 10, 2015
(86) PCT No.: PCT/US2015/035100

§ 371 Date: Dec. 11, 2016

(30) Foreign Application Priority Data
Jun. 11, 2014 (GB) 1410384.0

(51) Int. Cl. A23G 1/54; A23G 3/54; A23G 1/50

(52) U.S. Cl. CPC A23G 1/54; A23G 1/50; A23G 3/54; A23V 2002/00

(57) ABSTRACT

A confectionery item comprising at least two elongate fingers each of which comprises a filling encased within a chocolate layer or shell, wherein at least one of said fingers comprises a first filling and at least one other of the said fingers comprises a second filling which is different from said first filling, wherein the fingers are arranged in parallel to each other and conjoined along the length by means of the chocolate layer or shell and wherein the fingers are castellated or segmented along the length thereof. Methods for making the items and products comprising them are also described and claimed.

### FIELD

The present invention relates to a novel confectionery product including packaged forms thereof, to methods for manufacture of the product, as well as to packaging therefore.

### BACKGROUND

A wide variety of confectionery products are available to suit varied consumer tastes. Frequently, these products are composite products, comprising a variety of confectionery ingredients, including for example nougats, caramels including aerated caramels, toffees, fudges, nuts, wafers, biscuits, gels, flavoured creams or pralines. Often these are encased in chocolate and thus form the fillings of a confectionery product. In these cases, the chocolate adds significantly to the taste experience, but also acts to keep the other components isolated from the air, and thus prevents oxidation and spoilage.

In order to achieve an appealing taste sensation, combinations of fillings are frequently used in chocolate bars. Some fillings, such as nuts, biscuits and wafers, are essentially dry in nature and crisp in texture as a result of their friable or crunchy properties. If these alone are combined with chocolate, the product may not appeal to all tastes.

Other fillings are generally non-friable. These may be liquid, semi-solid or solid in texture. The more liquid fillings may provide a smooth taste sensation, whilst those with a greater degree of solidity can be chewy, or like chocolate, may undergo melting in the mouth. Examples include nougats, caramels, toffees, fudges, gels, flavoured creams or pralines. Confectionery products comprising chocolate with only non-friable fillings may provide a taste texture which is too cloying to appeal to all consumers.

Combination products comprising a filling made up of least one friable component such as biscuits, wafers or nuts, and at least one non-friable ingredient, encased within a chocolate coating are well known and very popular. For example, a Twix® bar comprises a biscuit covered with caramel, which is then coating with chocolate, but there are many other examples. The combination of components of contrasting textures and tastes leads to a more satisfactory sensory experience.

A difficulty associated with such products is that non-friable fillings generally comprise fairly significant levels of water. Over time, moisture may migrate from the non-friable fillings into the friable one. This reduces the crispness of the friable component and furthermore, can result in a drying and hardening of the non-friable filling. Thus, the shelf life of the products may be reduced as a result.

Confectionery products constructed to provide multiple individual compartments within a single integral chocolate bar or slab are also known. Generally, each compartment contains a single filling and they are designed to be eaten individually, for example after snapping apart the chocolate layers between the compartments. In some cases, each compartment contains a different filling to provide variety for the consumer. Examples include the Sky Bar® from Necco. However, many similar products, such as the Cadburys' Milk Tray bar, and the ‘Seven Up’ Candy bar have been withdrawn from the market.

Confectionery products comprising thin elongate bars or fingers are also well known. In particular, the Kit Kat® bar from Nestle, is a chocolate-covered wafer biscuit bar confection, in which either two or four wafer fingers are conjoined in a chocolate coating. The finger shape provides for an easy eating experience, and individual fingers may be readily separated from each other by snapping the chocolate between the individual fingers. However, this product does not provide the varied textures or taste experiences which appeal to many consumers as discussed above.

The applicants have developed a confectionery product which addresses some of these issues.

### BRIEF DESCRIPTION

According to the present invention there is provided a confectionery item comprising at least two elongate fingers each of which comprises a filling encased within a chocolate layer or shell, wherein at least one of said fingers comprises a first filling and at least one other of the said fingers comprises a second filling which is different from said first filling, wherein the fingers are arranged in parallel to each other and conjoined along the length by means of the chocolate layer or shell. In particular in the invention, the fingers are castellated or segmented along the length thereof, as described further below.

In another aspect, a method of preparing the confectionery item is provided. The method comprises moulding chocolate into an open conjoined finger structure, introducing a first filling into a first open finger section of said open conjoined finger structure, introducing a second filling into a second open finger section of said open conjoined finger structure, and sealing the open conjoined finger structure by application of chocolate thereto.

The confectionery item may also be packaged to provide a confectionery product and in another aspect the same is provided. The confectionery product comprises the confectionery item contained within a package.

### BRIEF DESCRIPTION OF THE DRAWINGS

Embodiments of the invention may be further understood with reference to the accompanying drawings in which:

FIGS. 1A-1C are grey scale, cross sectional representations of three embodiments of the confectionery;

FIG. 2 is a perspective representation of one embodiment of the confectionery;

FIGS. 3A-3F are schematic representations in cross section illustrating the production of the embodiments shown in FIG. 1 or 2;

FIGS. 4A-4B are schematic representations of an orthogonal view of one embodiment of a package suitable for use with embodiments of the confectionery;

FIGS. 5A-5C are schematic representations of one embodiment of a confectionery within (FIG. 5A), being withdrawn from (5B) and the remaining portion stored within (5C) the package shown in FIGS. 4A-4B; and

FIGS. 6A-6D are schematic illustrations taken in cross section of a range of confectionery profiles used in comparative sensory testing.

### DETAILED DESCRIPTION

As used herein, the term ‘finger’ or ‘fingers’ refers to an elongate generally rod-like elements which have a relatively narrow width. For example, the width of each finger may be in less than 2.5 cm for example from 1-2 cm in width, such as about 1.8 cm in width. In this arrangement, the consumer may bite through adjacent fingers simultaneously. In this case, the height of the fingers may also be selected to ensure that two fingers may be easily inserted into the mouth simultaneously. For example, the fingers may be from 0.8-1.5 cm high, and suitably about 1.15 cm high. Suitably also each finger will have a rounded profile on the upper surface thereof, so that there are no hard corners that may detract from the mouth-feel associated with the insertion of two fingers at the same time.

This allows for the consumption of two different fillings at the same time. This provides taste benefits of a combination of fillings in the mouth. Alternatively however, the consumer may taste the fingers individually according to individual preference, e.g., as by breaking apart adjacent fingers.

The first and second fillings will be different and so provide a range of taste experiences. The sorts of fillings that may be utilised as the first and second fillings are any of those utilised in or developed for the confectionery industry.

Whilst the first and second fillings may be similar in texture but differ in taste, for example, both may comprise different ‘luxury’ fillings such as nougats, pralines, creams, mousses or ganaches.

In a particular embodiment however, the first filling comprises one or more solid ingredients, in particular friable or crunchy ingredients or components, and the second comprises an essentially soft component, in particular a smooth or non-friable filling. In this embodiment, the presence of the solid ingredients in the first filling provides a different textural element to the taste sensation. In particular, the friable or crunchy ingredients or components may be effective to counter some of the cloying sensation produced by the smooth or non-friable filling, whilst the taste and ‘melting’ properties of the non-friable filling and the chocolate are retained.

However, the fact that the two fillings are isolated from each other by a shell or layer of chocolate before consumption means that permeation of liquid such as oil or water from one to the other is inhibited, and so each filling retains its original texture for longer. In particular, hard fillings have been found to retain their hardness better in an arrangement of the invention as compared to a conventional arrangement, in which hard and soft fillings may be arranged in a single consolidated bar. Thus the item has a good shelf-life.

Tests also suggest that separation of the fillings in this way may lead to a better taste sensation and in particular a better preservation of the flavour of a filling such as caramel as compared to a conventional arrangement, in which hard and soft fillings may be arranged in a single consolidated bar.

In a particular embodiment, the confectionery item consists of two fingers as described above, one containing the first filling and the other containing the second filling. Such an item may be narrow enough to fit easily into the mouth to allow the simultaneous consumption as described above.

Alternatively, the confectionery item may comprise a bar which includes more than two fingers, for example from 2-6 pairs of fingers, such as 4 pairs of fingers—or 8 individual fingers. These are suitably arranged in pairs, each pair comprising a finger containing the first filling and a finger containing the second filling arranged adjacent to it. In this embodiment, these pairs of fingers may be separable from the remaining fingers in the bar, for example by snapping apart the chocolate layer or shell between adjacent pairs. This may be facilitated if the chocolate layer or shell between the pairs is in the form of a breakable linker, suitably shaped like a ‘valley’, so that each pair can be readily snapped apart from the remainder of the bar. In general, the chocolate linker will be sufficiently thick so that it is strong enough to hold the bar together under normal circumstances, but may be snapped apart when opposing rotational pressures are applied to adjacent fingers simultaneously. Typically, the linker will be from 2.4-3.5 mm for example about 2.88 mm thick, but the precise thickness may be dependent upon the particular type of chocolate used to form the shell or layer.

Similar breakable linkers or valleys may be provided between the fingers of each pair also, so as to facilitate separate consumption if required by the consumer.

Each elongate finger may be shaped or profiled to increase their visual appeal and/or to modify the fit or feel of the bar in the mouth. For example, as discussed above, each finger will have a rounded profile on the upper surface thereof, so that there are no hard corners that may detract from the mouth-feel associated with the insertion of two fingers at the same time. In a particular embodiment, the cross sectional area of the fingers is varied along their length, for example to provide a ‘wave’ effect. The variation may be similar and along each finger of a pair, and provide a symmetrical pattern overall. However, the variation in shape of the fingers may differ, in which case, it is convenient if the variations in the two fingers are co-ordinated so that the overall width of a pair of fingers remains substantially constant. Thus, where one finger widens or has an increased cross sectional area, the other narrows by an equivalent amount, producing a co-ordinated structure.

Surface decoration may also be applied to the outer chocolate layer if required.

Individual fingers are segmented or castellated along their length to allow individual portions or small sections to be broken off cleanly. In this case, the castellation or segmentation in adjacent fingers is suitably aligned so that breaking along the segment lines results in a portion comprising small segments of both fingers. Again, this facilitates simultaneous consumption of sections of both fingers together if required. However, if required, the individual finger segments may be separated by further snapping along the valley between the fingers. Generally, there will be at least 3 and suitably from 4-8 segments formed along the length of the fingers, depending upon the actual length thereof. In bar or block arrangements, where multiple fingers are present, it may be more appropriate for each finger to contain only 2 segments so that individual fingers will extend laterally across the width of the bar or block.

Additionally, the depth of the sections or portions will be such as to allow a pair of adjacent sections to be readily inserted into the mouth for ease of consumption. For example, the sections or portions will suitably be from 2.5-4 cm in length.

In a particular embodiment, each finger comprises more than one filling, for example both the first and the second filling, arranged in different sections along the length of the finger. In a particular embodiment, the fillings in adjacent portions or sections along the length of each finger may be different. Thus each finger will comprise more than one filling but each filling is separated by means for example of chocolate layers that may be readily broken apart. In this way, the user may have a maximal selection in that they may break fingers apart lengthwise to provide two individual fingers, but more preferably may break pairs of fingers across sections to produce readily consumable pieces comprising segments of each finger. These may be eaten together or may, if required, be further divided into individual sections. Thus the consumer has maximal choice as to how he or she consumes the confectionery.

Thus, in a particular embodiment, each finger comprises both a first and a second filling as described above, arranged in alternating sections or segments along the length of the finger, and where adjacent sections or segments comprise a different one of the first or second filling.

In a particular embodiment, a bar or block is formed of numbers of elongate fingers, arranged in pairs, each pair comprising a first and a second finger, and adjoining the adjacent pair by a joint along the longitudinal side. Each finger is segmented along its length to provide a number of individual segments, for example, two or more such segments, for example up to 8 segments depending upon the dimensions of the bar or block. Appropriate fillings are introduced into alternate sections within a moulded chocolate shell.

In particular, where for example each finger comprises two segments, a first segment in a first finger comprises a first filling which is a hard filling such as biscuit as described above, and the other segment contains a second soft filling such as caramel. In this case, the first segment in the second finger will contain a soft filling, and the other segment will contain a hard filling so that adjacently arranged segments within the pair contain fillings of dissimilar nature and texture.

The upper surface of the fingers may be castellated with a generally square profile, or it may be generally rounded in shape. In the latter case, there is suitable a simple valley between the fingers and also valleys between segments. These valleys comprise essentially pure chocolate and may be snapped at the preference of the consumer to provide individual pairs of segments, individual fingers or individual segments.

The base of the bar is essentially planar to allow for it to be easily supported on a surface. For example, it may be stored in a tack-to-back′ arrangement with other similar bars. It may be provided with a lower layer or skirt which may be of variable depth.

The fingers may be of any length depending upon taste and requirements, but will generally be in the range of from 7-25 cm long, in particular from 9-15 cm long. The width of each finger is selected so that two adjacent fingers may be fitted in the mouth together. Typically this means that each finger is from 0.5-3 cm wide, for example from 0.8-1.6 cm wide such as from 0.8-1.2 cm wide.

First and second fillings used in the confectionery items will be selected from any that are available in the art, or they may be developed specifically for the purpose.

Where a filling and in particular the first filling comprises a solid component, these may be any component that remains essentially intact and integrated during the production process. Examples may comprise whole or dried fruit pieces such as pineapple, apple, orange or berry pieces for example strawberry, blackberry, raspberry or black currant pieces. In a particular embodiment however, as described above, the solid component will comprise one or more friable or crunchy ingredients. Examples of such ingredients include biscuits, shortcakes, cookies, wafers, honeycomb including malted honeycomb, or meringue which are either present in an integrated form or may be crumbled into pieces, or nuts which may be whole or broken into pieces.

Where the solid component of the filling is in multiple pieces, these may be held together by a suitable matrix or filler, such as chocolate, or other confections such as creams, truffles, nougats or caramels. Where the solid component is a friable or crunchy ingredient, the matrix or filler is suitably one where permeation of liquid such as moisture, from the matrix is low or limited so as not to cause rapid softening or deterioration of the texture of the solid component. Thus, in particular, the matrix will be chocolate or a high-fat based mixture, such as high-fat truffles or creams.

The relative amounts of solid component and matrix or filler will depend upon factors such as the nature of the solid component, whether or not it is a friable or crunchy ingredient, the nature of the matrix and the texture sought. Typically however, the ratio of solid component in the filling as compared to matrix or filler is in the range of 1:10 to 1:2 for example from 1:2 to 1:5. In such cases, the filling will typically comprise from 10-20% wt of the solid component. Generally, depending upon the size and arrangement of the fingers, this will mean that the overall product comprises up to about 5% by weight for example from 2-4% by weight of the solid component.

Alternatively, the first filling may comprise a crunchy or hard confection such as a hard sugar-based confection such as hard toffee or caramel or brittle. A classification of parameters of textures of foods is set out in Szczesniak et al. J. Food Science (1963) 28, 397, the content of which is incorporated herein by reference. In that classification, hardness is measured on a scale of from 1 to 9 with cream cheese being 1 on the scale and rock candy being 9. As used herein, the expression ‘hard’ typically refers to fillings which have a hardness in excess of 5 and preferably from 6-9 on that scale. Similarly, soft fillings will be classified as having a hardness of less than 5, preferably from 1-4 suitably from 1-2 on that scale.

Hard fillings may also have high levels of brittleness or chewiness on the scales set out in Szczesniak supra. In particular, hard fillings may have a brittleness rating of from 2-7 on the Szczesniak scale, and/or a chewiness rating of from 4 to 7. Measurement of parameters such as hardness and brittleness can be made using for example using probes and compression apparatus known in the art. For example, Food Technology Corporation (USA) offers break force and hardness testing using cylinder probes, spherical probes, compression probes and compression platens.

Examples of soft fillings that may be used in the items of the invention, in particular as second fillings include fillings comprising one or more non-friable ingredients such as nougats, fudges, mousses, caramels, toffees, creams, truffles, ganaches or pralines. They may generally be softer than the first filling and are frequently smooth or even liquid in nature.

In a particular embodiment, the second filling may comprise a mixture of a liquid composition such as a caramel or cream composition and chocolate. The chocolate is suitably added in a sufficient amount to modify the properties of the liquid composition as required. For example, it may be added to give the desired consistency to the liquid composition, for example by increasing the viscosity of the composition, or it may be used to modify the colour or flavour of the liquid composition to the required amount. Therefore relative amounts of the liquid composition and the chocolate will vary depending upon factors such as the particular nature of the liquid composition and the required level of viscosity. Typically however, the composition may comprise liquid component to chocolate in a weight ratio of from 50:1 to 5:1, for example from 10:1 to 50:1. Generally, where chocolate is mixed with a liquid composition, it may comprise 2-10% by weight of the filling.

Suitably, where individual fingers comprise more than one filling as discussed above, the fillings provided in adjacent segments on different fingers will each comprise one hard and one soft filling as discussed above. This allows the same complementary consistency effects to be achieved, if the consumer bites across two fingers simultaneously.

Chocolate used as the outer layer or shell for the fillings or as a component of the fillings may be any of the available chocolates include dark (milk or plain) chocolate, light chocolate or compound chocolate. The chocolate outer layer or shell is suitably sufficiently thick to isolate the fillings from the air, and may be thicker depending upon taste requirements. Typically, the outer layer will be from 0.5-5 mm thick.

The precise chocolate content of the confectionery content overall will vary depending upon factors such as the thickness of the shell or outer layer, as well as the nature of the fillings and whether either or any of these include chocolate as a component. Typically however, the confectionery item may comprise up to 85% by weight of chocolate, for example from 50-80% by weight.

Confectionery items as described above may be produced on a manufacturing scale. A variety of manufacturing techniques may be employed.

In a particular embodiment, the invention provides a method for preparing a confectionery item as described above, said method comprising moulding chocolate into an open conjoined finger structure, introducing a first filling into a first open finger section of said open conjoined finger structure, introducing a second filling into a second open finger section of said open conjoined finger structure, and sealing the open conjoined finger structure by application of chocolate thereto.

The first and second fillings may be introduced into the open conjoined finger structure sequentially or simultaneously depending on factors such as the relative viscosities of the fillings and the technology involved.

The open conjoined finger structure may take various forms. It may for example be open along the length of each finger on one side thereof, or alternatively, it may be open at one end of each finger.

Preferably, for ease of access, the open conjoined finger structure is open along substantially the entire length of each finger on one side thereof, as illustrated hereinafter.

Moulding of the chocolate to form the open conjoined finger structure may be carried out using any of the available techniques. In particular however, the structure may be prepared using “frozen cone” technology. Molten chocolate may be poured into a mould, which has the profile of one side of the bar. In this case, the mould will contain indentations which are arranged to form one surface of the bar comprising the fingers, including any profiling on the upper surface or castellation or segmentation. Each finger indentation is separated from the adjacent one by a ridge, adapted to form the dividing breakpoint or valley in the final product.

An upper mould or plunger, held at a low temperature for example from −10-30° C. is then lowered into the pool of molten chocolate in the base of the mould, forcing it to coat the sides of the mould including over the ridge and solidify.

The upper mould may also be profiled to provide for any internal structures required in the final product. For example, areas that need to be particularly strong to avoid premature or inadvertent breakage, for example, in areas adjacent to any castellation or segmentation, may be arranged so that the chocolate is thicker in these areas by providing appropriate indentations in the upper mould.

Alternatively, hollow chocolate fingers, which are open at one end, may be prepared in a suitable generally tubular mould. In this case, the hollow chocolate fingers are sealed at one end with chocolate and open at the other to allow a filling to be introduced into the hollow space.

In particular, each pair of hollow chocolate fingers are produced in a conjoined form in a suitable mould. Each finger is then filled individually with the different fillings through the open end. If necessary, the filling operation may be accompanied by shaking or agitation to ensure that the filling penetrates the full length of the finger.

Once filled to a suitable level, the open regions of the fingers will be sealed by applying melted chocolate over the opening.

Where the fingers are open along the entire rear surface, this may take the form of a ‘backing off’ operation in which chocolate is applied so as to form a chocolate layer across the entire rear surface of the bar comprising the fingers, thus completing a coherent shell or layer around the entire bar. In this case, the rear surface is suitably flat, to provide a base upon which the bar may be stably supported on surfaces. Similar procedures may be applied where the fingers are open only at an end region, where melted chocolate is applied to the open end region and then allowed to set. Alternatively, where the tubes are filled only to a level below the upper surface of the finger, the open end may be sealed by melting the chocolate at the end portion of the finger over the opening.

It may also be possible to produce individual hollow fingers initially, and then conjoin them together, either before or after introduction of the fillings, for example by partially melting and fusing the chocolate of the fingers.

Once manufactured in this way, the confectionery items of the invention are suitably packaged for sale.

In a further aspect, the invention provides a confectionery product comprising a confectionery item as described above, contained within a package.

Suitable packages comprise films or wraps, in particular, polymer films such as polypropylene including orientated polypropylene, polyethylene or nylon films which may monolayer films or they may be metalized or 2 ply films including a metal layer. Typically, such films will be from 20-40 μm thick.

In a particular embodiment, the package is arranged to allow access to an end region of both fingers simultaneously, to encourage biting both fingers simultaneously. This may suitably be achieved by providing a detachable portion or releasable flap extending across the end regions of two fingers.

Detachable portions or flaps may be created by scoring the packaging film, for example with a laser, at the appropriate position. The use of a 2-ply metalized film as the packaging material is particularly useful in this context, as the laser is then able to cut through the top layer, but reflects off the metalized layer, forming a line of weakness which can be readily torn off.

Tearing along the score line may be facilitated by provision of a tear nick or strip which is suitably provided with a pull tag. This leads to a straight end surface in the region of the exposed portion of the item, allowing it to be accessed easily.

The flap may be totally removable from the remainder of the packaging so as to expose an end portion of the fingers for consumption.

Suitably, the removable portion or flap is arranged directly opposite or just above any first castellation or segmentation from one end of the fingers. In this way, removal of the portion or release of the flap will expose an appropriate segment of the fingers to allow the consumer to remove or eat a single segment or, where the confectionery item consists of a single pair of adjacent fingers, a pair of adjacent segments, one from each finger, simultaneously. Typically, this will mean that taking account of any seal at the end of the package, the removable portion or flap will be arranged at from 2.5-6 cm from an end of the package, for example about 4 cm from the end.

The exposed portion of the fingers may then be consumed, but the remainder of the bar formed by the fingers remains within an open ‘container’ made up of the packaging remaining after removal of the flap. Further sections may be exposed for consumption by simply propelling the bar formed by the fingers up through the residual container from the base.

If the bar is not to be consumed immediately, this propulsion operation will not be performed and the bar will be retained within the packaging, ensuring that it has not direct contact with surfaces on which it may be placed for storage. Similarly, if the bar has been propelled some way out of the residual packaging but not entirely consumed, it may be allowed to drop back into the residual container and will be kept isolated from direct contact with the environment.

Alternatively, the flap may be designed so that it remains attached to the container, for example at one side. In this embodiment, the problem of disposal of two items of packaging is avoided. Furthermore, the remaining flap may be folded over the exposed or open end of the container to further isolate the confectionery item for storage, if not consumed in a single event.

Alternatively, the end region of a joint, and in particular a longitudinal joint, present in the packaging may be of an ‘easy open’ construction.

In a particular embodiment, the end surface of the packaging is serrated, which facilitate downward tearing of the packaging, if required by the consumer.

Packaging is suitably prepared from films which have been preprinted with the desired information and marketing material. These films are also scored as described above to generate the desired final package.

These may be applied around the confectionery item using conventional techniques such as flow wrapping. Films may be hot or cold sealed to form a complete package around the item, and cut or crimped to separate individual products. In a particular embodiment, the packaging is prepared by a cold sealing process in which adhesive, which may be pressure sensitive, is applied to the films in the areas required to be sealed, and these areas are brought together to form a seam that closes the packaging around the final bar.

### Example 1

### Preparation of Confectionery Item

Tempered chocolate at 29° C. was placed in a suitably shaped dual finger segmented mould. The mould was placed on a vibrating table for approximately 15-20 seconds to remove excess air bubbles. The mould was then turned over onto a wire rack, which was also placed on the vibrating table and vibrated for about 10 seconds in order to remove excess chocolate.

Excess chocolate was removed from the mould with a scraper, and the mould was placed face down onto a metal rod or wire rack. The chocolate was allowed to set for approximately 5 minutes, so that two conjoined adjacent hollow fingers or compartments were formed, which were sealed at one end and open at the other.

A caramel type filling was then placed into one of the cavities within the chocolate structure, which was then vibrated to allow the filling to level off.

A second filling, this time a mix of chocolate and small biscuit (shortcake) pieces was placed into the other cavity within the chocolate structure. The structure was again vibrated to allow the filling to level off.

The open ends of the cavities were checked to see that they were free of filling and the fillings were allowed to set for 15 minutes.

The open edges of the cavities in the chocolate structure were lightly warmed with a hot air blower. Tempered chocolate was then applied to the end to seal the opening. The chocolate was smoothed and leveled and the product was cooled to 10° C. for 30-40 minutes to ensure that the product was fully set.

The product was de-moulded onto a dry cool surface in a controlled environment. It was then allowed to return to room temperature over a period of from 15-20 minutes and then sent for packaging.

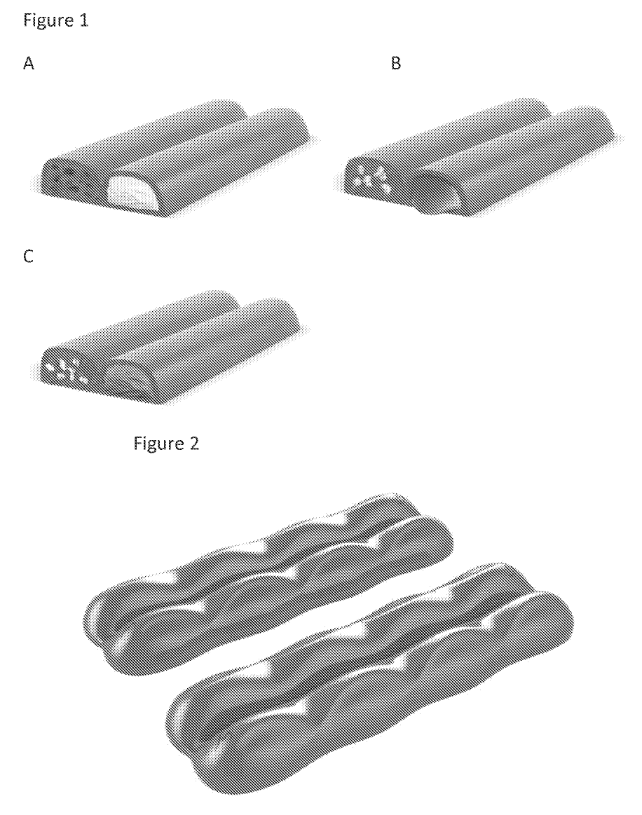

In this way, products as illustrated in FIGS. 1 and 2 could be prepared.

### Example 2

### Alternative Preparation of Confectionery Item

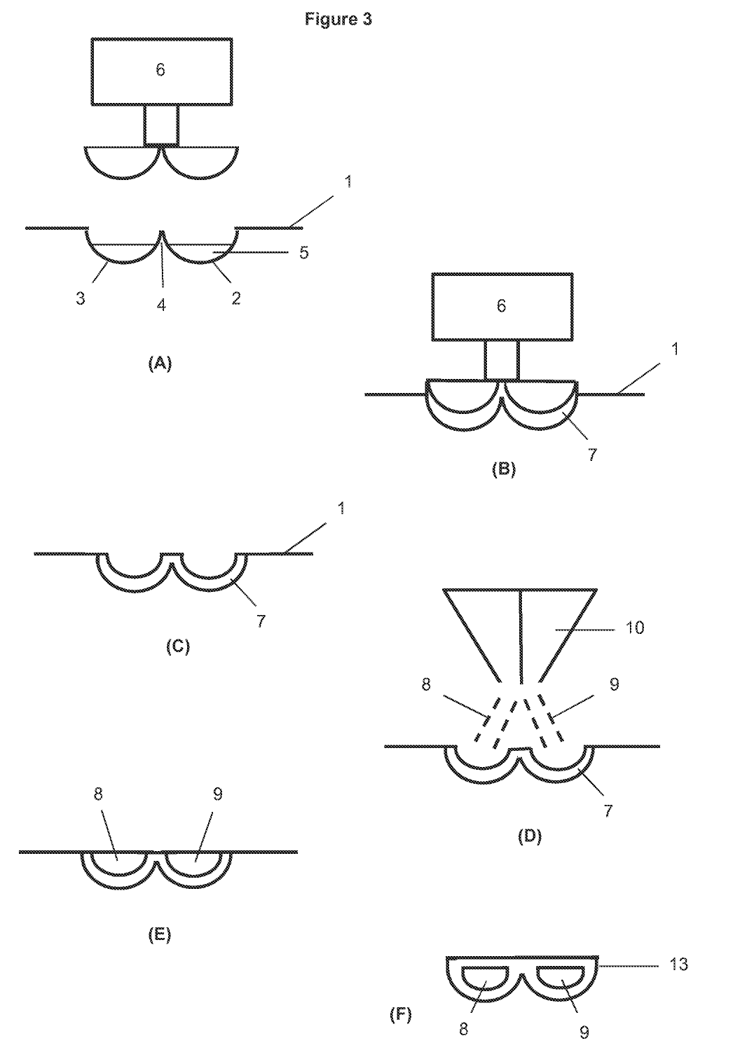

An alternative method for preparing products illustrated in FIGS. 1 and 2 is shown in FIG. 3. In this Figure, a mould (1) comprising indentations (2,3) corresponding to individual fingers, separated by a ridge (4) is shown in cross section (FIG. 3A). The shape of the indentations (2,3) in the longitudinal direction may be varied as described above, but they will be segmented in some way. Sufficient molten chocolate (5) to form a chocolate shell or layer for the confectionery item with the exception of a back or base surface is poured into the indentations (2,3).

A profiled plunger (6) held at −25° C. is then lowered into the molten chocolate (5), causing it to coat substantially the entire inner surface of the indentations (2,3), including overflowing the ridge (4)(FIG. 3B). The chocolate (5) is set forming an open finger structure (7). The plunger (6) is removed (FIG. 3C).

Each finger of the open finger structure (7) is then filled with a different filling (8, 9). The fillings may be added individually, for example at different work stations within a production line, or they may be applied simultaneously from a single hopper (10) which is subdivided into two sections (11, 12) each containing a different filling (8,9)(FIG. 3D)

Molten chocolate may then be applied to the filled structure (14) in a conventional ‘backing off’ process. Excess chocolate may be removed by means of a roller, forming a sealed product (13) which is then removed from the mould, ready for packaging as required (FIG. 3F).

### Example 3

### Packaging of Confectionery Item

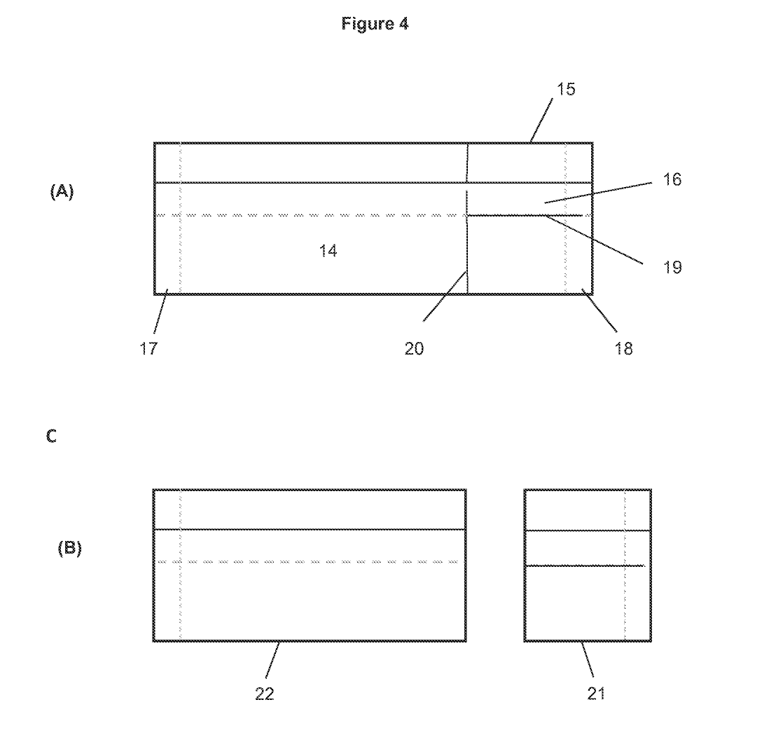

An example of packaging that may be suitable for use in products in accordance with the invention is shown in FIG. 4. The package comprises a 2-ply metalized film (14) which has been cut and formed, using a cold sealing process, into a rectangular package (15), having a longitudinal seam (16) and lateral seams (17, 18) at either end and around a product as illustrated in FIGS. 1 and 2 (product not shown in FIG. 4). Each edge surface at the ends (24, 25) of the package is provided with serrations (FIGS. 4A and 4B).

A score line (20) is provided though the non-metal layer of the film (14) extending around the package (15). The score line (20) is arranged towards one end of the package (15), in particular at about 4 cm from the serrated end (25), so as to provide a clean opening in the region of the first segmentation or castellation point from the end of a confectionery item held within the package (15). The score line extends sufficiently far around the package (15) to allow it to be used to facilitate opening. Generally, this means that it will extend substantially around the entire package (15) although it may stop just short of the edges of the film edge so as to minimise the risk of the film snapping.

A tear nick (not shown) may be provided around the score line (20).

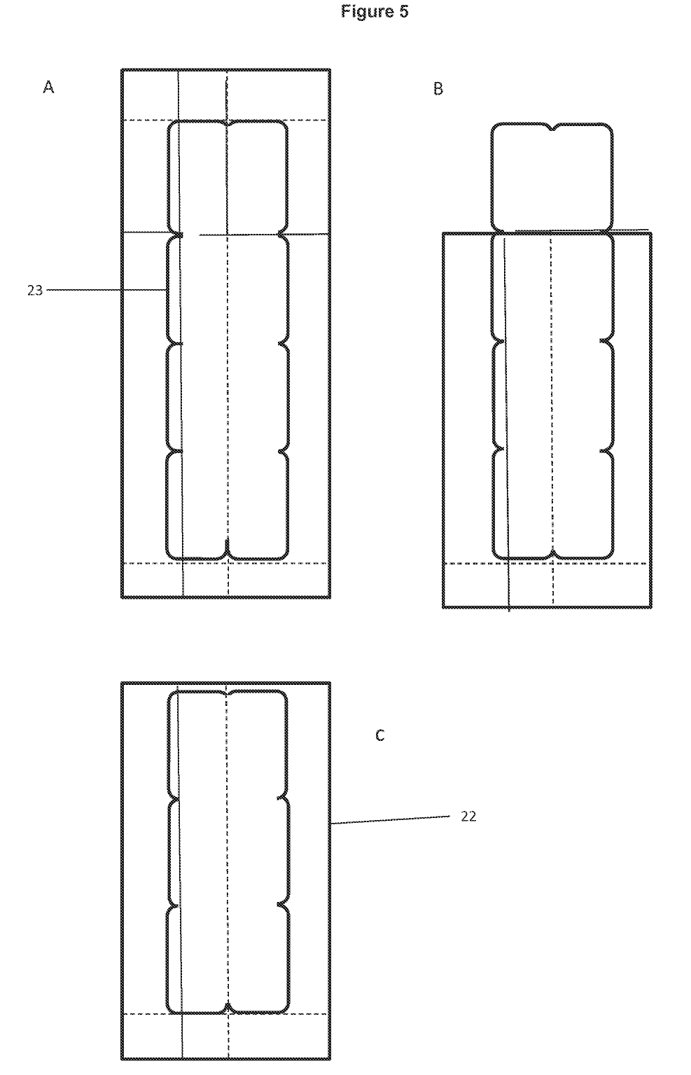

In use, as shown in FIGS. 5A-5C, a confectionery item (23) within the package (15) may be accessed by tearing along the score line (20), with the assistance of a tear nick when provided. This results in the complete removal of an end portion (21) from the package (15) (FIG. 5B), allowing easy and clean access to an end portion of both fingers of the confectionery item.

The confectionery item (23) may then be consumed by eating both fingers together or separately at the taste of the consumer. The residual package section (22) provides a convenient holding container for the confectionery item (23) during consumption and also provides a useful storage container for any product not consumed in one go (FIG. 5C).

The confectionery item (23) may then be consumed by eating both fingers together or separately at the taste of the consumer. The residual package section (22) provides a convenient holding container for the confectionery item (23) during consumption (FIG. 5B) and also provides a useful storage container for any product not consumed in one go (FIG. 5C) since it is of a suitable size to hold the residual portion.

Alternatively, the detachable portion (21) may be used as a cover to cap the uneaten product (not shown in FIG. 5).

### Example 4

### Comparison of Sensory Properties of Confectionery of the Invention as Compared to Conventional Consolidated Arrangement

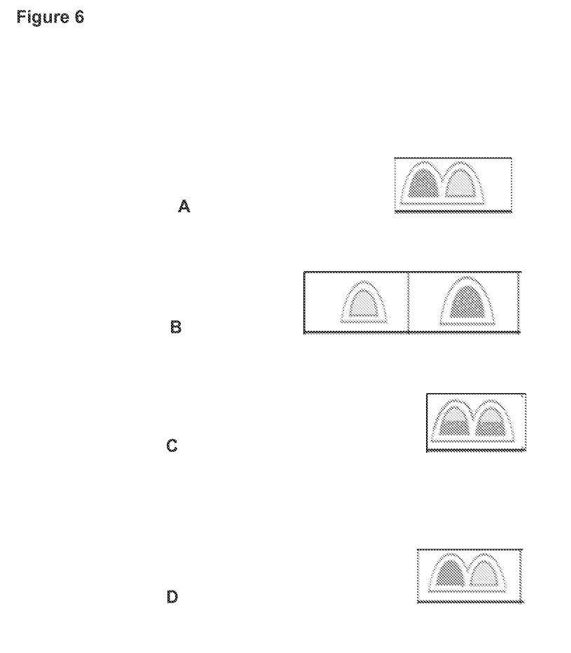

Samples were produced having a variety of profiles as illustrated in FIG. 6. The various forms were then assessed during a QDA profile by a panel of 16 sensory trained experts.

The profile was realised under controlled conditions, in which samples were coded with three digit number for anonymous distribution to the sensory experts, the temperature of the room was set to 20° C. and a red light was used in the testing booths so that the experts were unable to visually observe differences.

The experts were asked to assess hardness on the basis of at first bite with incisive teeth going through in one go across the product section. The experts were then required to assess the hardness on the basis of the amount of force, ranging from nil-extreme, required to break through the sample with the front teeth.

The soft filling was assessed on the contrast in bite and dense attributes.

The results showed a statistically significant increase in the hardness of the arrangement of FIGS. 6A, 6B and 6D as compared to FIG. 6C, suggesting that the separation of the components provided a better retention of the hardness properties.

1. A confectionery item comprising at least two elongate fingers each of which comprises a filling encased within a chocolate layer or shell, wherein at least one of said fingers comprises a first filling and at least one other of the said fingers comprises a second filling which is different from said first filling, wherein the fingers are arranged in parallel to each other and conjoined along the length by means of the chocolate layer or shell and wherein the fingers are castellated or segmented along the length thereof.

2. The confectionery item of claim 1, consisting of two fingers.

3. The confectionery item of claim 1, comprising multiple pairs of fingers arranged in a bar or block.

4. The confectionery item of claim 1, wherein the cross sectional area of each fingers is varied along their length.

5. The confectionery item of claim 1, wherein the first filling comprises one or more solid ingredients and the second filling comprises a soft component.

6. The confectionery item of claim 5, wherein the one or more solid ingredients of the first filling are selected from one or more friable or crunchy ingredients or components.

7. The confectionery item of claim 6, wherein the friable or crunchy ingredients or components of the first filling are selected from biscuits, shortcakes, cookies, wafers, honeycomb including malted honeycomb, meringue or nuts, any of which may be whole or broken into small pieces.

8. The confectionery item of claim 4, wherein the solid components of the first filling are in pieces which are held in a matrix or filler.

9. The confectionery item of claim 8, wherein the matrix or filler comprises chocolate.

10. The confectionery item of claim 4, wherein the second filling is a smooth or non-friable filling.

11. The confectionery item of claim 10, wherein the second filling is selected from nougat, caramel, toffee, fudge, gel, flavoured cream or praline.

12. The confectionery item of claim 11, wherein each finger comprises more than one filling.

13. The confectionery item of claim 12, wherein each finger comprises both the first and the second filling, arranged in different sections along the length of the finger, and wherein each segment comprising a first filling is adjacent to a segment comprising a second filling on the adjoining finger.

14. A method for preparing a confectionery item comprising moulding chocolate into an open conjoined finger structure, introducing a first filling into a first open finger section of said open conjoined finger structure, introducing a second filling into a second open finger section of said open conjoined finger structure, and sealing the open conjoined finger structure by application of chocolate thereto.

15. The method of claim 14, wherein the open conjoined finger structure is prepared by frozen cone technology.

16. A confectionery product comprising a confectionery item contained within a package, wherein the confectionery item comprises at least two elongate fingers each of which comprises a filling encased within a chocolate layer or shell, wherein at least one of said fingers comprises a first filling and at least one other of the said fingers comprises a second filling which is different from said first filling, wherein the fingers are arranged in parallel to each other and conjoined along the length by means of the chocolate layer or shell and wherein the fingers are castellated or segmented along the length thereof.

17. The confectionery product of claim 16, wherein the confectionery item consists of two fingers and the package is arranged to allow access to an end region of both fingers simultaneously.

18. The confectionery product of claim 17, wherein the package comprises a removable portion or releasable flap extending across the end regions of two fingers.

19. The confectionery product of claim 18, wherein the removable portion or releasable flap is arranged to be opposite to or just above a first castellation or segmentation from the end of a confectionery item within the package.

20. (canceled)
